(19) United States
(12) Patent Application Publication
(10) Pub. No.: US 2006/0282820 A1
(43) Pub. Date: Dec. 14, 2006

(54) COBOL syntax for native XML file parsing and file generation

(75) Inventor: Cinderella Lee, Richmond Hill (CA)

Correspondence Address: International Business Machines;Intellectual Property Law, Dept. T81/503, 3039 Cornwallis Road, P.O. Box 12195, Research Triangle Park, NC, 27709, US

(73) Assignee: INTERNATIONAL BUSINESS MACHINES CORPORATION, ARMONK, NY (US)

(21) Appl. No.: 11/148,541

(22) Filed: Jun. 9, 2005

(51) Int. Cl. G06F 9/44

(52) U.S. Cl. 717/114

(57) ABSTRACT

Embodiments of the present invention address deficiencies of the art in respect to XML processing in a COBOL environment and provide a method, system and apparatus for processing a COBOL syntax to allow native XML parsing. In a method of the invention, COBOL source code can be processed and an XML processing directive can be detected in the COBOL source code. In any case, a file path can be extracted from the XML processing directive in the processed COBOL source code. Subsequently, object code can be produced that is configured to process XML data in an XML document stored at a location specified by the file path. Specifically, the object can be configured to parse XML data in an XML document stored at a location specified by the file path, or to generate XML data in an XML document stored at a location specified by the file path.

### FIELD OF THE INVENTION

The present invention relates to computer programming languages and more particularly to XML file parsing and generation within COBOL program code.

### DESCRIPTION OF THE RELATED ART

The Extensible Markup Language (XML) is a general-purpose markup language for creating special-purpose markup languages. XML is a simplified subset of the standardized generalized markup language, capable of describing many different kinds of data. The primary purpose of XML is to facilitate the sharing of data across different systems, particularly systems connected via the Internet. Languages based upon XML are themselves described in a formal way, allowing some programs to modify and validate documents in these languages without prior knowledge of their form.

Computing applications can incorporate XML document processing through any number of internal and external mechanisms. Generally speaking, however, most read an XML document into memory and produce a data tree for data nodes in the XML document. Referred to as a document object model (DOM), application logic subsequently can traverse the nodes of the DOM to process the XML data. Aside from the DOM, another application programming interface (API), the Simplified API for XML (SAX) is widely used to process XML data. Typically, SAX is used for serial processing whereas DOM is used for random-access processing.

To process an XML document, SAX utilizes call backs. When the SAX parser object recognizes a component in an XML document, for instance a start Element, an end Element, and the characters between tags, the SAX parser can call a method that may be supplied by the application to process the XML component. In the Java programming environment, for example, the SAX parser can call the processing method by subclassing a handler class such as the DefaultHandler. In consequence, the SAX parser can build an object from the extracted XML data which can be manipulated from within the code of the programming environment.

In the COBOL programming environment, unlike other programming environments, certain limitations exist in respect to the processing of XML documents. Generally, the format for a COBOL instruction directing the parsing of an XML document can include, 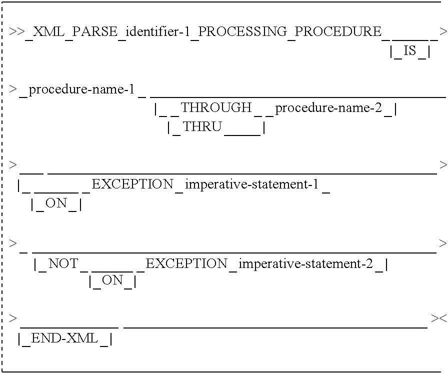
where the variable “identifier-1” is an alphanumeric or national data item that contains the XML document character stream.

Likewise, the format for a COBOL instruction directing the generation of an XML document can include, 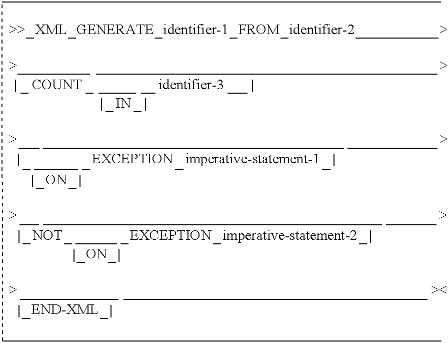
where the variable “identifier-1” is an alphanumeric or national data item that contains the proposed XML document character stream, and where the variable “identifier-2” is any national data item or double-byte character set data item. Notably, the variable “identifier-1 ” must be large enough to contain the generated XML document character stream--typically five to eight times the size of the raw data specified by the variable “identifier-2”.

Principal limitations for parsing XML documents in the COBOL environment relate to the size of XML document character streams which can be parsed natively. For example, several known COBOL compilers for both midrange and mainframe computing platforms do not permit the parsing of XML document streams which exceed a pre-set size such as sixteen megabytes (MB). Moreover, the memory loading of the XML document stream for processing natively in COBOL code inherently limits the use of the in-memory representation of the XML document stream to the application defined by the COBOL code.

### BRIEF SUMMARY OF THE INVENTION

Embodiments of the present invention address deficiencies of the art in respect to XML processing in a COBOL environment and provide a novel and non-obvious method, system and apparatus for processing a COBOL syntax to allow native XML parsing. In a method of the invention, COBOL source code can be processed and an XML processing directive can be detected in the COBOL source code. In any case, a file path can be extracted from the XML processing directive in the processed COBOL source code. Subsequently, object code can be produced that is configured to process XML data in an XML document stored at a location specified by the file path. Specifically, the object code can be configured to parse XML data in an XML document stored at a location specified by the file path, or to generate XML data in an XML document stored at a location specified by the file path.

A system for processing a COBOL syntax to allow native XML parsing can include a COBOL compiler, a data store, for example an integrated file system (IFS) file store in a midrange computing device such as the iSeries(TM) server from IBM Corporation of Armonk, New York, configured to store an XML document, and XML parse/generate processing logic coupled to the COBOL compiler and to the data store. The XML parse/generate processing logic can be configured to process COBOL source code and to detect an XML processing directive in the COBOL source code. The XML parse/generate processing logic further can be configured to extract a file path from the XML processing directive in the processed COBOL source code, and to produce object code configured to process XML data in the XML document stored at a location in the data store specified by the file path.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a COBOL programming environment configured to process a COBOL syntax to allow native XML parsing; and,

FIG. 2 is a flow chart illustrating a method for processing a COBOL syntax to allow native XML parsing in a COBOL environment.

### DETAILED DESCRIPTION OF THE INVENTION

Embodiments of the present invention provide a method, system and computer program product for parsing and generating XML natively within the COBOL environment. In accordance with an embodiment of the present invention, a COBOL processing directive can be recognized in the course of compiling COBOL source code as one of an XML parsing and an XML generating statement. A file location for an XML document can be extracted from the directive. Subsequently, for an XML parsing instruction, XML data within an XML document at the file location can be parsed such that events within the XML data can be handled by specified COBOL procedures in the directive. Likewise, for an XML generating instruction, data accessed from within the COBOL environment can be converted to XML data and written to an XML document at the file location.

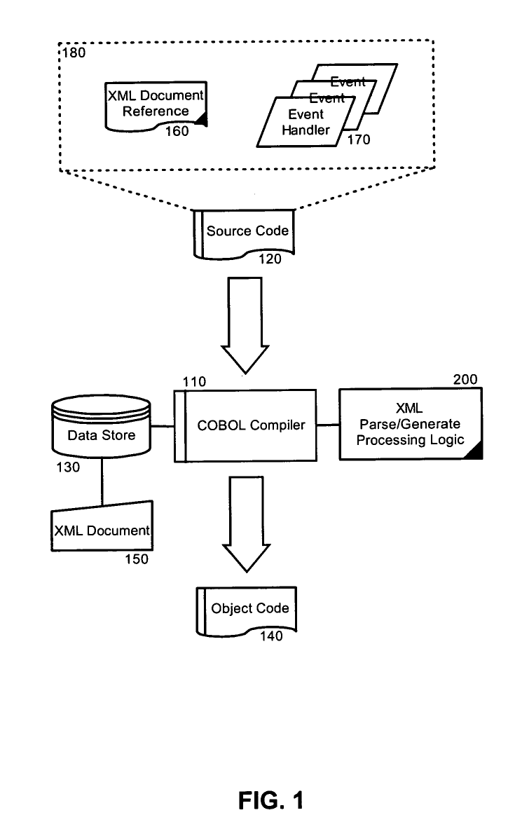

In further illustration, FIG. 1 is a schematic illustration of a COBOL programming environment configured to process a COBOL syntax to allow native XML parsing. The COBOL programming environment can include a COBOL compiler 110. The COBOL compiler 110 can be configured to process COBOL source code 120 to produce object code 140 for execution in a computing platform. The COBOL compiler 110 can be coupled to a data store 130 which can include one or more XML formatted documents 150. Also, the COBOL compiler 110 can be coupled to (or can include) XML parse/generate processing logic 200.

The XML parse/generate processing logic 200 can include program code to identify a directive 180 for either parsing the XML document 150, or for generating the XML document 150. The directive 180, itself, can include an XML document reference 160 for the file location of the XML document 150 in the data store 130. In the circumstance where the directive is one to parse the XML document 150, one or more event handlers 170 further can be specified within the directive 180 to handle events in the XML data of the XML document 150 as they are identified during parsing. In this way, size limitations for XML data can be exceeded by avoiding an in-memory parsing of the XML document 150. Moreover, the XML document 150 while residing in the data store 130 can be accessed by multiple applications and not just the application represented by the object code 140.

An exemplary form of the directive 180 for parsing the XML document 150 follows:

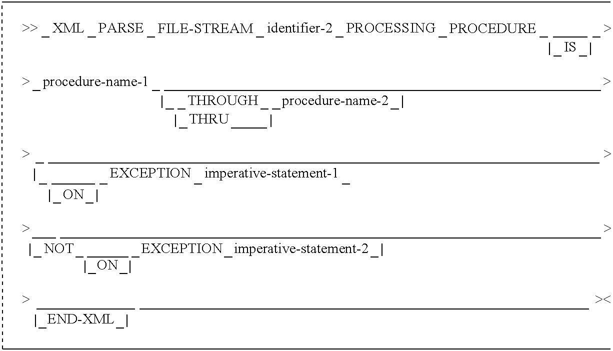

In the exemplary directive, the variable “identifier-2” is an alphanumeric data item containing the absolute or relative path name of the stream file that contains the XML document. An absolute name can begin with the character “/”, for example “/u/user1/myxml”. A relative path name, by comparison, will not begin with the character “/”. Accordingly, the relative path name can be concatenated with a current directory to resolve the file path. XML documents, including ASCII XML documents, located in the specified stream file that do not contain an encoding declaration are parsed with the coded character set of the stream file.

The exemplary directive also includes a set of procedures which are to handle specified events generated by the parsing of the XML document referenced by the variable “identifier-2 ”. In this regard, the paragraph name, “procedure-name-1” specifies the first or only section or paragraph in the processing procedure, whereas the paragraph name, “procedure-name-2” specifies the last section or paragraph in the processing procedure. The processing procedure consists of the statements at which XML events detected by the parsing of an XML document are handled. The range of the processing procedure also includes all statements executed by CALL, EXIT, GO TO, GOBACK, and PERFORM statements in the range of the processing procedure.

The processing procedure, however, does not directly execute an XML PARSE statement. However, if the processing procedure passes control to an outermost program by using a CALL statement, the target program can execute the same or a different XML PARSE statement. A program executing on multiple threads can execute the same XML statement or different XML statements simultaneously. In this circumstance, the compiler can insert a return mechanism after the last statement in the processing procedure. Otherwise, the processing procedure can terminate the run unit with a STOP RUN statement. In either case, however, the compiler does not attempt to return to the parser with a GOBACK or EXIT PROGRAM statement.

As another example, an exemplary form of the directive 180 for generating the XML document 150 follows:

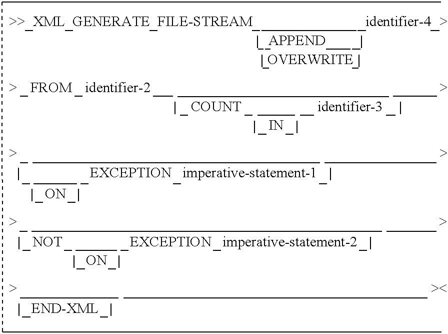

In the exemplary directive, where the FILE-STREAM keyword is specified, the converted XML data can be saved to a file that is specified by the variable, “identifier-4”. Also, when no APPEND or OVERWRITE keyword is used, a new file can be created and the converted XML data will be saved into the new file. However, if the APPEND keyword is used, the converted XML data will be appended to the existing file. Likewise, if the OVERWRITE keyword is used, the existing file can be replaced by a new file. The file itself can be specified by a pathname which can be absolute, or relative to a current directory.

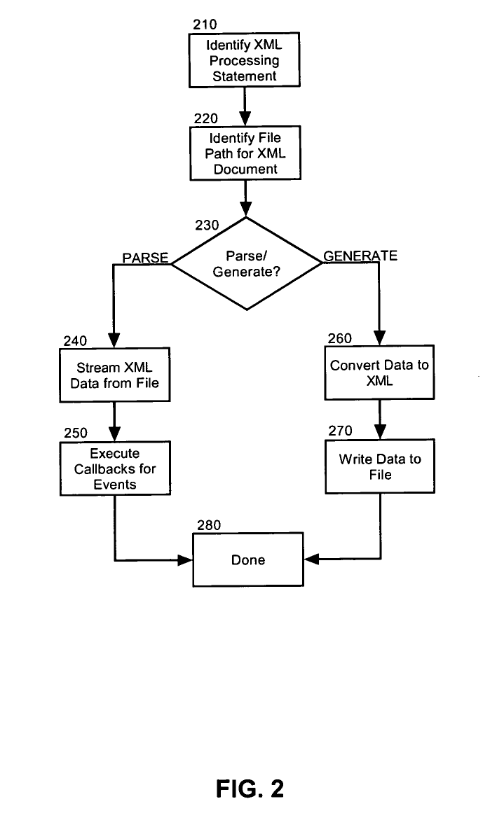

In further illustration of the operation of the XML parse/generate processing logic 200, FIG. 2 is a flow chart illustrating a method for processing a COBOL syntax to allow native XML parsing in a COBOL environment. Beginning in block 210, an XML processing directive can be detected within COBOL source code. In block 220, a file path for the XML processing directive can be detected. In decision block 230, it can be determined whether the XML processing directive is a directive for parsing an XML document from a file, or whether the XML processing directive is a directive for generating an XML document.

If, in decision block 230, it is determined that the directive is one to parse XML data from an XML document stored in a file, the XML document can be retrieved from file storage at a location specified by the file path in block 240. Subsequently, in block 250 as the XML data in the XML document is parsed, associated callback procedures can be executed as specified within the directive for events in the XML data. By comparison, in block 230, if it is determined that the directive is one to generate an XML document, in block 260, specified data can be converted to an XML format and in block 270 the XML formatted data can be written to the file specified file path. Finally, in block 280 the process can end.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for processing a COBOL syntax to allow native extensible markup language (XML) parsing, the method comprising:
processing COBOL source code and detecting an XML processing directive;
extracting a file path from said XML processing directive in said processed COBOL source code; and,
producing object code configured to process XML data in an XML document stored at a location specified by said file path.

2. The method of claim 1, wherein said processing comprises:
compiling said COBOL source code to produce object code for said COBOL source code; and,
during said compiling, detecting said XML processing directive.

3. The method of claim 1, wherein said file path is a relative path to said XML document.

4. The method of claim 1, wherein said file path is an absolute path to said XML document.

5. The method of claim 1, wherein said producing comprises producing object code configured to parse XML data in an XML document stored at a location specified by said file path.

6. The method of claim 1, wherein said producing comprises producing object code configured to generate XML data in an XML document stored at a location specified by said file path.

7. The method of claim 5, wherein said producing comprises:
reading a plurality of callback procedures within said directive that are configured to handle events in said XML document; and,
producing object code to call selected ones of said callback procedures upon detecting corresponding events in said XML document.

8. The method of claim 6, wherein said producing comprises producing object code configured to generate XML data and to one of overwrite XML data in an XML document stored at a location specified by said file path with said generated XML data, append said generated XML data to follow existing XML data in an XML document stored at a location specified by said file path, and write said generated XML data to a new XML document created at a location specified by said file path.

9. A system for processing a COBOL syntax to allow native extensible markup language (XML) parsing, the system comprising:
a COBOL compiler;
a data store configured to store an XML document; and,
XML parse/generate processing logic coupled to said COBOL compiler and to said data store, and configured to process COBOL source code and detect an XML processing directive in said COBOL source code, to extract a file path from said XML processing directive in said processed COBOL source code, and to produce object code configured to process XML data in said XML document stored at a location in said data store specified by said file path.

10. The system of claim 9, where said XML processing directive comprises a plurality of callback procedures within said directive that are configured to handle events in said XML document.

11. The system of claim 9, where said XML processing directive comprises a keyword specifying whether to append XML data to said XML document, whether to overwrite XML data in said XML document, or whether to add XML data to a newly created XML document.

12. A computer program product comprising a computer usable medium having computer usable program code for processing a COBOL syntax to allow native extensible markup language (XML) parsing, said computer program product including:
computer usable program code for processing COBOL source code and detecting an XML processing directive;
computer usable program code for extracting a file path from said XML processing directive in said processed COBOL source code; and,
computer usable program code for producing object code configured to process XML data in an XML document stored at a location specified by said file path.

13. The computer program product of claim 12, wherein said computer usable program code for processing object code configured to process XML data in an XML document stored at a location specified by said file path comprises:
computer usable program code for compiling said COBOL source code to produce object code for said COBOL source code; and,
computer usable program code for detecting said XML processing directive during said compiling.

14. The computer program product of claim 12, wherein said file path is a relative path to said XML document.

15. The computer program product of claim 12, wherein said file path is an absolute path to said XML document.

16. The computer program product of claim 12, wherein said computer usable program code for producing object code configured to process XML data in an XML document stored at a location specified by said file path comprises computer usable program code for producing object code configured to parse XML data in an XML document stored at a location specified by said file path.

17. The computer program product of claim 12, wherein said computer usable program code for producing object code configured to process XML data in an XML document stored at a location specified by said file path comprises computer usable program code for producing object code configured to generate XML data in an XML document stored at a location specified by said file path.

18. The computer program product of claim 16, wherein said computer usable program code for producing object code configured to process XML data in an XML document stored at a location specified by said file path comprises:
computer usable program code for reading a plurality of callback procedures within said directive that are configured to handle events in said XML document; and,
computer usable program code for producing object code to call selected ones of said callback procedures upon detecting corresponding events in said XML document.

19. The computer program product of claim 17, wherein said computer usable program code for producing object code configured to process XML data in an XML document stored at a location specified by said file path comprises computer usable program code for producing object code configured to generate XML data and to one of overwrite XML data in an XML document stored at a location specified by said file path with said generated XML data, append said generated XML data to follow existing XML data in an XML document stored at a location specified by said file path, and write said generated XML data to a new XML document created at a location specified by said file path.
